(19) United States
(12) Patent Application Publication
(10) Pub. No.: US 2008/0048951 A1
(43) Pub. Date: Feb. 28, 2008

(54) Method and apparatus for managing and uniformly maintaining pixel circuitry in a flat panel display

(76) Inventors: Walter Edward Naugler JR., Katy, TX (US); Donald T. Wile, San Jose, CA (US); Kapil Vinod Sakariya, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/710,462

(22) Filed: Feb. 22, 2007

Related U.S. Application Data
(60) Provisional application No. 60/792,266, filed on Apr. 13, 2006.

(51) Int. Cl. G09G 3/32

(52) U.S. Cl. 345/82

(57) ABSTRACT

The present invention describes a method and apparatus for measuring the voltage and current characteristics of the OLED pixel as it ages and correlating the measured data to the decrease in quantum efficiency and changes in OLED impedance over the life of the OLED, so that corrections can be made to the image drive system to prevent image sticking and color point drift. The method and apparatus of the present invention do not require any additional circuitry or changes in the display design. The circuitry of the present invention is implemented in the display driver integrated circuit (IC) chips. The basis of the invention is the luminance-current-voltage (LIV) curves which characterize the OLED materials over their life time. A series of these curves are stored in memory representing a OLED material at various ages. The apparatus of the present invention is used to measure driver voltages and currents for a pixel having an OLED, which measurements are then used to extract the voltage current curve for the OLED at any point in time. The extracted curve is compared to the aging curves stored in memory to determine the aging curve that best describes the measured present voltage current characteristic of the pixel. That aging curve is used to drive the pixel.

### RELATED APPLICATION

The present application claims priority from the U.S. Provisional Patent Application No. 60/792,266, filed on Apr. 13, 2006.

### FIELD OF INVENTION

The present invention relates to flat panel displays.

### BACKGROUND OF THE INVENTION

Solid-state organic light emitting diode (OLED) displays are of great interest as a superior flat-panel display technology. These displays utilize current passing through thin films of organic materials to generate light. The color of the light emitted and the efficiency of the energy conversion from current to light are determined by the composition of the organic thin film material. Different organic materials emit different colors of light.

As the display is used, however, the organic materials in the display age and become less efficient at emitting light. This reduces the lifetime of the display, and causes image sticking and loss of color balance. The OLED materials used for generating the various colors age at different rates. For example, the blue OLED material usually ages faster that the red and the green OLED materials, and the white balance drifts to pink and yellow due to lack of blue light.

The rate at which the OLED materials age is related to the amount of current that passes through the display. The amount of current that passes through the display is representative of the amount of light emitted by the display. One technique to compensate for this aging effect in polymer light emitting diodes is described in U.S. Pat. No. 6,456,016 issued Sep. 24, 2002 to Sundahl et al. This approach relies on a controlled reduction of current provided at an early stage of use followed by a second stage in which the display output is gradually decreased. This solution requires that the operating time of the display be tracked by a timer within the controller, which then provides a compensating amount of current. Moreover, once a display has been in use, the controller must remain associated with that display to avoid errors in display operating time.

The Sundahl technique applies a correction to the display on a global basis rather on a pixel by pixel basis and therefore, does not account for excessive aging in pixels that are used more frequently than other pixels. This is a problem for laptop computers running software that display menu bars and corporate logos that will rapidly age the pixels that are constantly being used. Another example is the signal indicator in a cellular telephone. As the phone display is used the bars representing signal strength will burn into the display and eventually always indicate full signal strength. The Sundahl technique will not prevent the burn-in (image sticking).

U.S. Pat. No. 6,414,661 B1 issued Jul. 2, 2002 to Shen et al. describes a method and associated system that compensates for long-term variations in the light-emitting efficiency of individual diodes (pixels) in an OLED display, by calculating and predicting the decay in light output efficiency of each pixel based on the accumulated drive current applied to the pixel and derives a correction coefficient that is applied to the next drive current for each pixel. This technique requires the measurement and accumulation of drive current applied to each pixel, requiring a stored memory that must be continuously updated as the display is used, requiring complex and extensive circuitry. The total amount of current does not always predict aging since high current for a short time causes the OLED materials to age faster than a low current for a longer time even though the total accumulation of current may be the same in both cases.

U.S. Patent Application Publication nos. 2003/0071821 A1 and 2004/0212573 A1 (both publications being the same document) describe measuring the currents through pixels and measuring voltage changes across the pixels, and making corrections to the drive voltages of the pixels based on the total amount of the measured current and/or the voltage changes. The total current flow and voltage changes are used to estimate the age of a pixel, and the corrections are based on the age estimates for each pixel. This technique is similar to the technique described in the preceding paragraph for the Shen patent. The documents do not explain how the currents and voltages are measured. Therefore, even though measurement systems are mentioned, none are described to enable someone trained in the art to produce a working model based on the information in the two publications.

U.S. Patent Application 2002/0167474 A1 by Everitt, published Nov. 14, 2002, describes a pulse width modulation driver for an OLED display. One embodiment of the video display in Everitt comprises a voltage driver for providing a selected voltage to drive an organic light emitting diode in a video display. The voltage driver may receive voltage information from a correction table that accounts for aging, column resistance, row resistance, and other diode characteristics. In one embodiment of the invention, the correction tables are calculated prior to and/or during normal circuit operation. Since the OLED output light level is assumed to be linear with respect to OLED current, the correction scheme is based on sending a known current through the OLED diode for a period sufficiently long to allow the transients to settle out and then measuring the corresponding voltage with an analog-to-digital converter (A/D) residing on the column driver. A calibration current source and the A/D can be switched to any column through a switching matrix. This design requires the use of an integrated, calibrated current source and A/D converter, greatly increasing the complexity of the circuit design. Furthermore, the voltage measured in such a system can only be across the OLED in a passive matrix display. For active matrix displays the observed voltage would be across both the OLED and the drive transistor, thereby obscuring the actual voltage across the OLED.

U.S. Pat. No. 6,504,565 B1 issued Jan. 7, 2003 to Narita et al., describes a light-emitting display which includes a light-emitting element array formed by arranging a plurality of light-emitting elements, a driving unit for driving the light-emitting element array to emit light from each of the light-emitting elements, a memory unit for storing the number of light emissions for each light-emitting element of the light-emitting array, and a control unit for controlling the driving unit based on the information stored in the memory unit so that the amount of light emitted from each light-emitting element is held constant.

Narita also discloses an exposure display employing the light-emitting display, and an image forming apparatus employing the exposure display. This design requires the use of a calculation unit responsive to each signal sent to the each pixel to record usage, thereby greatly increasing the complexity of the circuit design. Furthermore, the Narita technique attempts to measure the age of a pixel by its history of on time, i.e. the amount of current flowing through the pixel. The Narita technique is flawed due to the fact that both the amount of current flowing through the pixel and the rate of current flow through the pixel contribute to the pixel's aging. Simply measuring the amount of current flow is not good enough to make the corrections to the pixel drive voltage.

JP 2002278514 A by Numeo Koji, published Sep. 27, 2002, describes a method in which a prescribed voltage is applied to organic EL elements by a current-measuring circuit and the current flows are measured. Also, a temperature measurement circuit estimates the temperature of the organic EL elements. The measured values are then compared with corresponding values of similarly constituted elements determined beforehand to determine changes due to aging. Then, the total sum of the amount of currents being supplied to the elements is changed, for the interval during which display data are displayed, so as to obtain the originally desired luminance based on the estimated values of the current-luminance characteristics, the values of the current flowing in the elements, and the display data.

This design presumes a predictable relative use of pixels and does not accommodate differences in actual usage of groups of pixels or of individual pixels. Hence, the correction for color or spatial groups (image sticking) is likely to be inaccurate over time. Moreover, the integration of temperature and multiple current sensing circuits within the display is required. This integration is complex, reduces manufacturing yields, and takes up space within the display.

U.S. Patent Application 2003/0122813 A1 entitled “Panel Display Driving Display and Driving Method” to Ishizuki et al., published Jul. 3, 2003, discloses a display panel driving device and driving method for providing high-quality images without irregular luminance over a long period of use of the display. According to the Ishizuki technique, the value of the light-emission drive current flow causing each light emission element bearing each pixel to independently emit light in succession is measured. Then, the luminance is corrected for each input pixel datum based on the above light-emission drive current values associated with the pixels corresponding to the input pixel datum. According to another aspect of Ishizuki, the value of the drive voltage is adjusted in such a manner that one value among each measured light-emission drive current value becomes equal to a predetermined reference current value. According to a further aspect of Ishizuki, the current value is measured while an off-set current component corresponding to a leakage current of the display panel is added to the current outputted from the drive voltage generator circuit, and the resultant current is supplied to each of the pixel portions.

The Ishizuki design presumes an external current detection circuit that is sensitive enough to detect the relative current changes in a display due to a single pixel's power usage. Such circuits are difficult to design and expensive to build. Moreover, the Ishizuki method uses current alone to correct the OLED aging, and ignores the fact that the light emission from OLED material decays even if constant current is fed to the material.

U.S. Pat. No. 6,995,519 B2, issued Feb. 7, 2006 to Arnold et al., describes an apparatus comprising an organic light emitting diode (OLED) display, comprising:

a) an array of OLED display light-emitting elements, each OLED display light-emitting element having two terminals;

b) a voltage sensing circuit for each OLED display light-emitting element in the display array including a transistor in each circuit connected to one of the terminals of a corresponding OLED display light-emitting for sensing the voltage across the OLED display light-emitting element, and to produce feedback signals representing the voltage across the OLED display light-emitting elements in the display array; and

c) a controller responsive to the feedback signals for calculating a correction signal for each OLED display emitting-emitting element and applying the correction signal to data used to drive each OLED display light-emitting element to compensate for the changes in the output of each OLED display light-emitting element.

This design requires a custom pixel design having an additional thin film transistor included within the pixel area. That lowers production yield, increases cost and reduces the emission area of the pixel, thereby requiring the OLED material to be driven harder to make up for the loss of emission area which will cause the OLED material to age faster. Moreover, the integrated circuits used to drive the system will only operate with the custom pixel design, therefore limiting the available market for the driver ICs. Moreover, the design only measures the voltage change as the pixel ages and disregards the reduction in quantum efficiency.

Moreover, the circuit used by Arnold et al., to measure the voltage on the OLED, applies the voltage at the anode of the OLED to the gate of a thin film transistor, which causes the thin film transistor to pass current through a resistor 15 as shown in prior art FIG. 1a and FIG. 1b. The circuits shown in both figures are well known active matrix driver circuits for OLED displays. Image data 26 from the computer display board is sent to controller 16. Controller 16 sends image data in the form of an analog voltage (DATA) to the display using control lines 24. The select line turns on the data transistor and the data voltage is stored on Vcap and also applied to the current transistor driving OLED 10. When the OLED pixel is turned on, by applying data voltage, current passes through OLED 10 causing the emission of light. As current passes through OLED 10, a voltage develops on the OLED anode, which voltage is applied to the gate of transistor 12. That turns on transistor 12 and causes current to pass through resistor 15.

When current is passed through resistor 15, a voltage is developed that is proportional to the voltage on the gate of transistor 12 (which is the voltage on the OLED). One problem with doing this is that the amount of current passed by transistor 12 in one pixel is not the same as the current passed through transistor 12 in another pixel, or even in an adjacent pixel due to process variances in the manufacturing process. Therefore, the voltage reading is subject to a high degree of error. Moreover, resistor 15 in FIG. 1b is actually a thin film resistor deposed inside the pixel with the current measuring circuit. It is well known in the industry that thin film resistors need to be trimmed in order to produce uniform results; therefore such a pixel current measuring circuit would be prohibitively expensive to produce.

There is a need, therefore, for an improved aging compensation approach for organic light-emitting diode displays. The techniques cited above variously use current as the light emission controlling agent, or use the amount of current passing through the OLED material to gauge aging. In the active matrix display there are two main issues: 1) how to deal with non-uniform emissions due to the irregularities in the active matrix drive system, and 2) how to deal with the aging of the OLED materials. The following disclosure shows both the methods and the apparatus to produce both initial uniformity in the display and how to correct for aging of the display. The present invention provides solutions without adding components to or changing the display. Therefore, the invention can be applied to any OLED display regardless of design.

### SUMMARY OF THE INVENTION

A method of measuring the current and voltage across the OLED drive transistor and the OLED without having to add circuitry to the pixel is described. The method entails scanning gate voltages of the drive transistor in the linear and saturated regions to obtain the threshold voltage and electron mobility for the drive transistor. The threshold and electron mobility are used to calculate the source/drain voltage across the transistor for a range of currents so that voltages across the OLED for a range of currents can be calculated.

In order to use the measured data, the OLED material is thoroughly characterized in the laboratory to determine its aging characteristics in terms of voltage and current values required to obtain various levels of light emissions from the OLED. The life of the OLED (time to half brightness) is divided into a number of periods. The greater the number of age periods the more accurate the aging correction. At the end of each aging period, two curves are developed: the voltage versus luminance curve and the voltage versus current curve. These curves are called the LIV curves for Luminance, current (I) and Voltage. If there are 64 periods, for example, there will be 64 sets of LIV curves.

By knowing which voltage versus current curve the OLED is currently on, the age period of the OLED is known. By knowing the age period of the OLED, the proper voltage versus luminance curve is known. These curves are stored in memory with the first curve set (the Tzero LIV curve set) being assigned to each sub-pixel in the display. As the pixel passes through each of the 64 age periods to the end of its life, the assigned LIV curve set number is increased from 0 to 63. The voltage and current measurements are used to determine when the pixel has passed from one age period to another. The age determining process can be done when the display system is not being used. For example, in a cellular phone, the display is not used most of the time when the phone is in use or on standby. It is during this time that the age calibration process can be done.

### DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1a illustrates a prior art embodiment of a voltage measuring circuit in an OLED display pixel;

FIG. 1b illustrates another prior art embodiment of a voltage measuring circuit in an OLED display pixel;

FIG. 2a is a graph illustrating the change in OLED voltage over time at constant current;

FIG. 2b is a graph illustrating the change in OLED luminance over time at constant current;

FIG. 3 is a graph illustrating the change in Blue OLED luminance versus voltage at three different ages;

FIG. 4 is a graph illustrating the change in Blue OLED voltage versus current at three ages;

FIG. 5 illustrates the combined curves of FIG. 3 and FIG. 4 into the LIV curves at different age points;

FIG. 6a illustrates an OLED drive circuitry in the pixel;

FIG. 6b illustrates measured versus calculated OLED voltage curve over time;

FIG. 7 illustrates a pixel current capture circuit;

FIG. 7a illustrates the position of the pertinent switches of the circuitry FIG. 7 during the reset operation;

FIG. 7b illustrates the position of the pertinent switches of the circuitry FIG. 7 during the data settling operation;

FIG. 7c illustrates the position of the pertinent switches of the circuitry FIG. 7 during the integration operation;

FIG. 7d illustrates the position of the pertinent switches of the circuitry FIG. 7 during the convert; and

FIG. 8 illustrates a timing diagram for a pixel current capture circuit of FIG. 7.

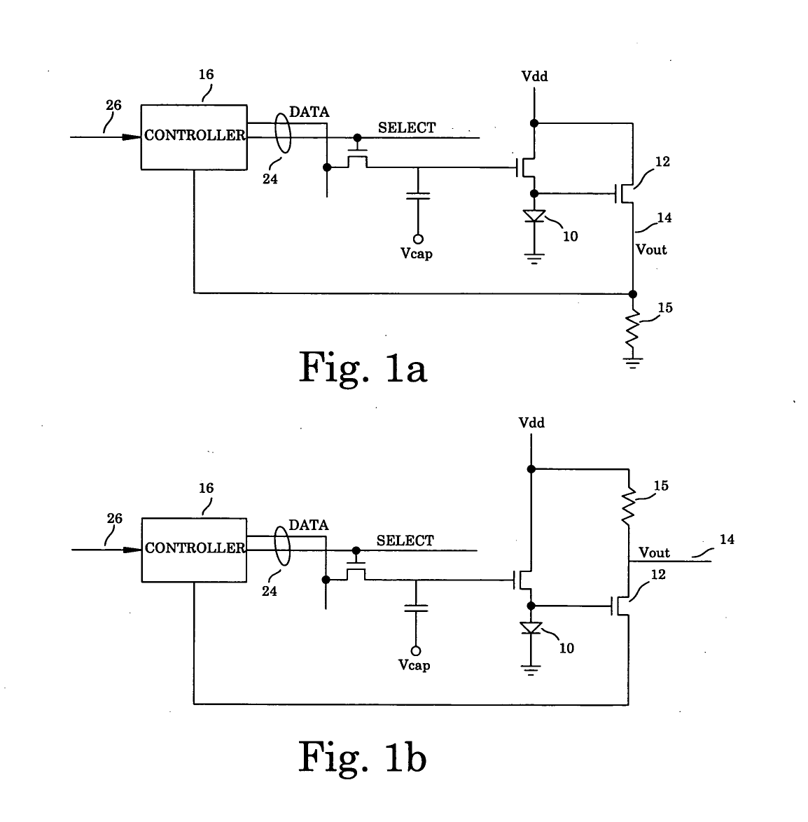

### DETAILED DESCRIPTION OF THE INVENTION

The Development of the Luminance/Current/Voltage (LIV) Curves

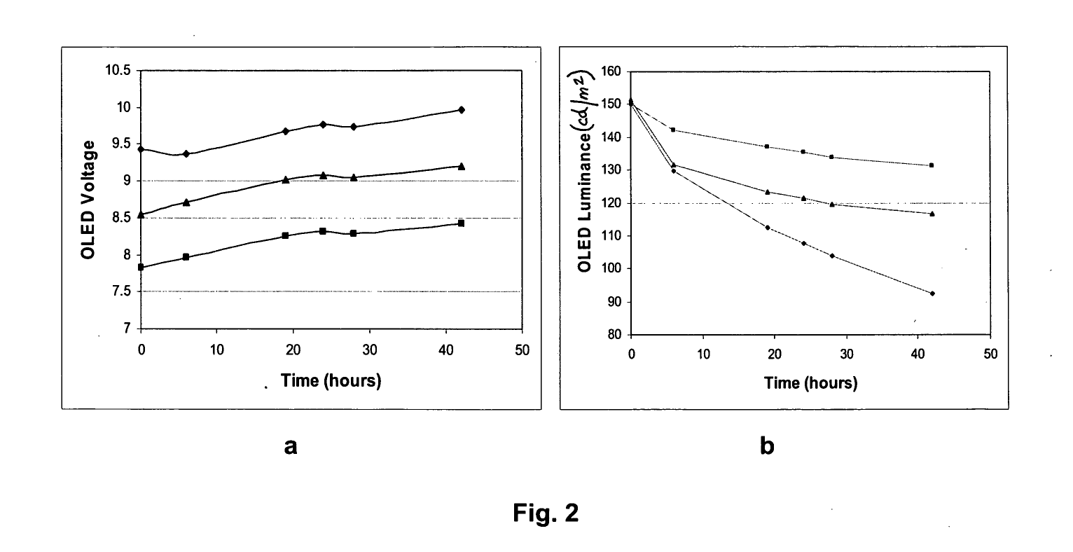

This invention is based on the aging properties of the organic light-emitting diode materials. The voltage/current characteristics of the OLED change as it ages. FIG. 2 shows the changes in voltage across and the light output of the OLED over time, for a constant current of the OLED. FIG. 2a plots voltage at constant drive current over time, indicating that the voltage increases as the material ages. FIG. 2b indicates that if a constant current is supplied to the OLED, the OLED luminance decreases with time.

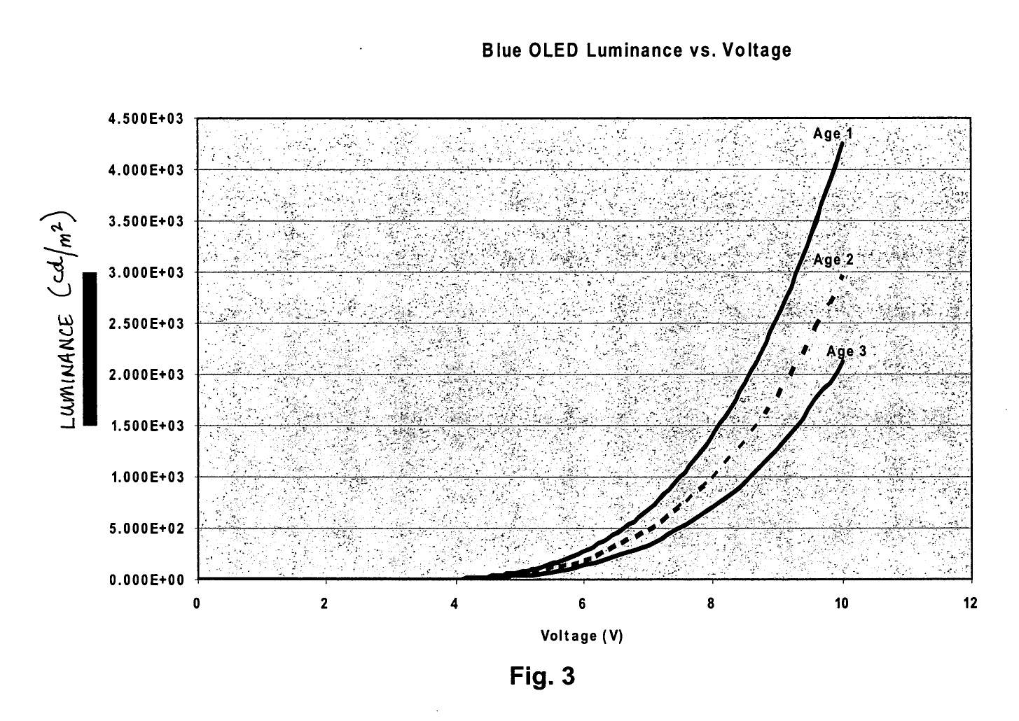

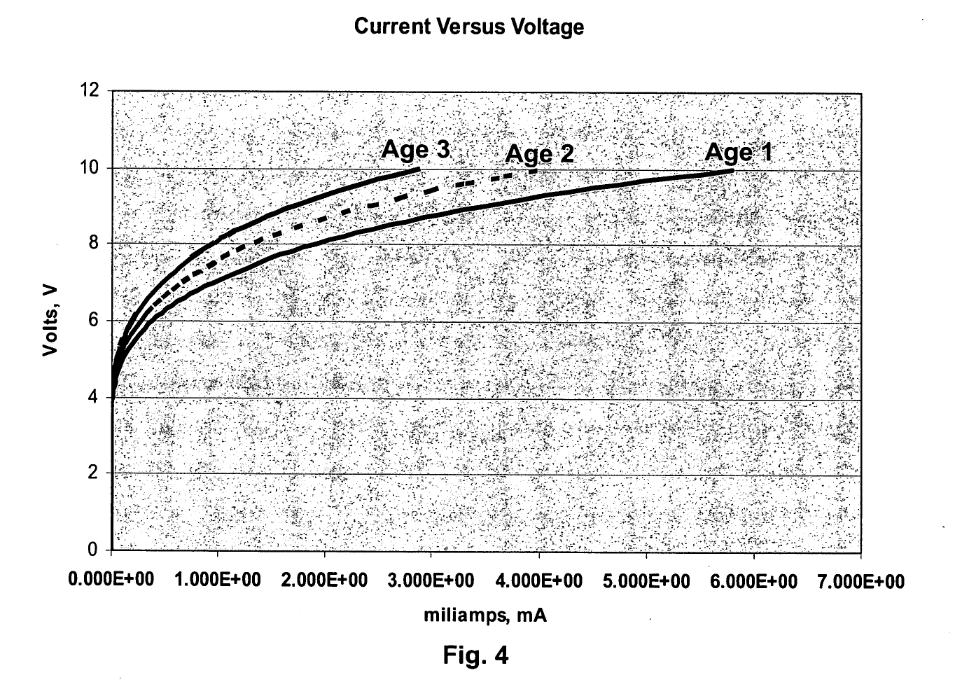

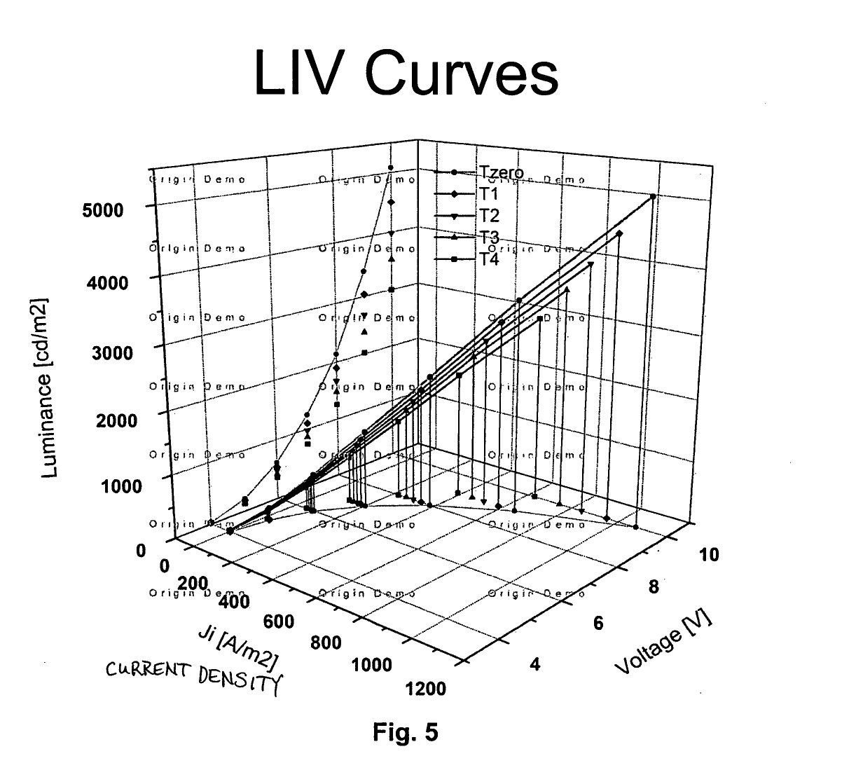

At any point in the age of the OLED material, the luminance output can be plotted against the applied voltage and a graph curve plotted. FIG. 3 shows the luminance output plotted against the applied voltage for three age points. Of the curves shown in FIG. 3, age 1 curve represents the OLED at an earlier age than age 2 curve does, and the age 2 curve represents the OLED at an earlier age than the age 3 curve does. FIG. 4 shows the same OLED material with current plotted against voltage for the same age periods. Note that the common element between FIGS. 3 and 4 is the voltage. Therefore, for each voltage point there is a luminance and a current. FIG. 5 is a combination the curves shown in FIGS. 3 and 4.

According to an aspect of the present invention, at any age of the OLED, a set of luminance/voltage/current curves can be plotted. FIGS. 2, 3, 4 and 5 only show a few simulated curves for clarity. These curves can be expressed as equations obtained by well know 20 curve fitting functions, referred to as regressions. As an example, the voltage versus luminance curve for age 1 is expressed by the following equation:
L=0.0031V⁶−0.1165V⁵+2.3794V⁴−13.538V³+27.037V²−15.993V

Note that this is a 6^{th} order equation which provides more accuracy than may be needed for a particular application. The actual order would be determined by the desired accuracy and the amount of memory reserved for the data. In one embodiment, in order to store this equation in memory, only the numerical coefficients (0.0031, −0.1165, 2.379, −13.538, 27.037, and 15.993), would be stored. The number of curve sets to be stored can be any number. Accuracy increases as the time period between curves decreases. For a 6 bit system, 64 sets of curves would be determined in the lab and saved in the system memory.

It can be seen that if a specific luminance is desired from the OLED, then it must be first established which age curve the OLED is on or nearest to. This is accomplished by taking the drive voltage and current measurements of the OLED and determining the curve equation using regressing mathematics. The coefficients of the measured curve are compared to the coefficients stored in memory and the curve in memory closest to the measured curve is used to determine the proper current required to give the desired luminance. The technique for using that current for rendering the image on the display is explained below.

Initial Uniformity Correction

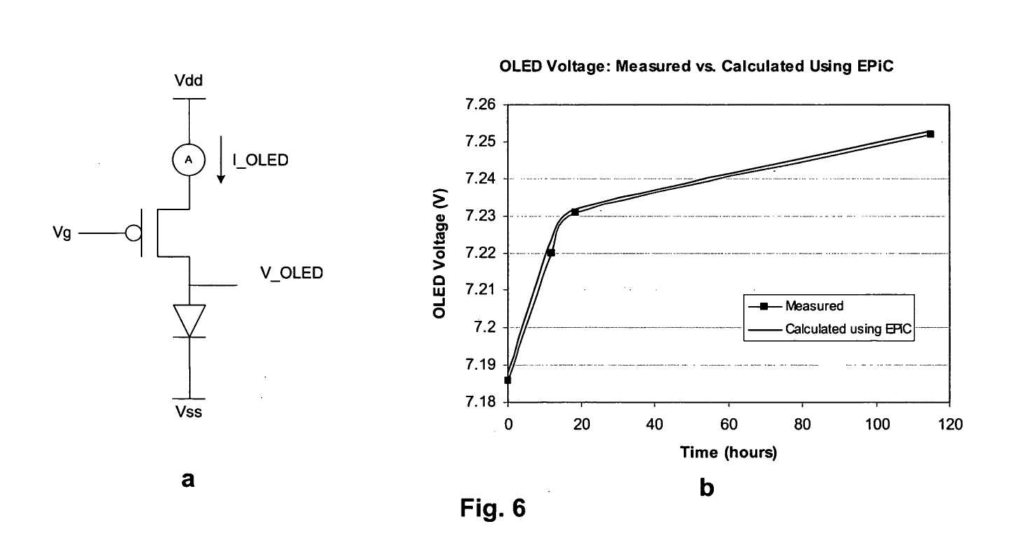

Correcting the initial non-uniformity in the OLED display requires that each driver transistor be calibrated for its gate voltage and output current. This is called as the Transistor Gate Voltage versus Drain Current Curve. From the LIV curves, the OLED current required to produce a desired emission level from the pixel is found. The drive transistor produces the desired current, if the correct gate voltage is applied to the drive transistor. FIG. 6 shows the OLED/drive-transistor circuit typically found in OLED display pixels. The voltage across both the drive transistor and the OLED is Vdd. Vss is ground. Vg is the gate voltage applied to the drive transistor and it determines the current flow through the drive transistor. The drive transistor is biased in the saturation region as is well known in the art so that the drive transistor acts as a current source. That is, the current supplied by the drive transistor is constant and independent of the load (the state of the OLED). V_OLED is the voltage drop between the source of the drive transistor (the anode of the OLED) and the cathode (ground) of the OLED. I_OLED is the current supplied by the drive transistor that passes through the OLED and causes light emission.

The drive transistors for the pixels in the display are made from thin film semiconductor processes well known in the industry. Thin films are known to have non-uniform or unstable electrical properties. Since there are literally millions of sub-pixels in high resolution displays, it is impossible to make all the transistors uniform over the large glass substrates used to make lap tops, computer monitors and television sets. Therefore, the current produced by a particular drive transistor for a specific gate voltage is not necessarily the same as the current produced by the drive transistor with the identically applied gate voltage in the next pixel. It is, therefore, necessary to develop the gate voltage/drain current curve for each transistor in the display. These transistor voltage/current curves are stored in memory in the identical manner as the LIV curves.
I_{D}=k·(V_{GS}−V_{T})² Equ. 1

I_{D} is the drive transistor current

k is a constant that includes the electron mobility of the transistor

V_{GS} is the gate to source voltage

V_{T} is the threshold voltage

Equation 1 is the model for the thin film transistor when it is biased in the saturation region in order to make it a current source independent of the load provided by the OLED. The following is the steps for developing a voltage/current curve for the OLED, and finding the values for k and V_{T}.

The display operating voltage, Vdd, places the TFT in the saturated region. By taking the current at two data values for I_{D1} and I_{D2}, equation 2 (below) can be used to obtain V_{T}. V_{T} can be substituted into equation 3 (below) to obtain k.

$$\begin{matrix}\begin{matrix}{V}_{ T} = \frac{1}{ 2 \cdot ( {I}_{ D 2} - {I}_{ D 1} )} \cdot [ - 2 \cdot {I}_{ D 1} \cdot {V}_{ GS 2} + 2 \cdot {I}_{ D 2} \cdot {V}_{ GS 1} + \\ 2 \cdot ( - 2 \cdot {I}_{ D 1} \cdot {V}_{ GS 2} {I}_{ D 2} \cdot {V}_{ GS 1} + {I}_{ D 2} \cdot {I}_{ D 1} \cdot {V}_{ GS 2}^{ 2} + \\ { {I}_{ D 1} \cdot {I}_{ D 2} \cdot {V}_{ GS 1}^{ 2} )}^{1 / 2} ]\end{matrix} & Equ . 2 \\ k = \frac{{I}_{1}}{{( {V}_{GS 1} - {V}_{T} )}^{2}} & Equ . 3 \\ {V}_{GS } = \sqrt{\frac{{I}_{D }}{k}} + {V}_{T} & Equ . 4\end{matrix}$$

Equation 4 is derived from equation 1. It is used to obtain the Gate voltage, V_{GS}, for a desired current, I_{D}, which is required to provide the desired emission level from the pixel.

In one embodiment, V_{T} and k for each drive transistor in each pixel are stored in memory. Then equation 4 is used to calculate the gate voltage V_{GS} required to produce the required OLED currents which are derived from the LIV curves. In another embodiment, a voltage to current curve is produced for each transistor and the coefficients of the curves stored in memory. The difference between the two embodiments is that storing the coefficients of actual curves may be more accurate that the use of a mathematical model.

The following describes how to develop the voltage to current curves. This operation is done when the display is not in use. Gray levels are numbered from darkest to brightest. The number of gray levels depends on the bit level used when digitizing the gray level for use by the logic system of the display controller. For example, a 6-bit gray level has 64 levels ranging from 0 to 63. An 8-bit gray level has 256 levels ranging from 0 to 255. The following is an example using a 6-bit system.

1. Set up Mode (performed to calibrate the power TFTs).
1.1 Create 64 (6-bit) current to gate voltage curves (Tzero data)
   1.1.1 Starting with a high gray level (for example, 60), input the digital number 60 and measure the current produced for each pixel. This is an example. The actual gray level may be any of the gray levels.
   1.1.2 Test all drive transistors in the display to determine the lowest current pixel and the highest current pixel at the V_{GS} designated by the display operating system or gray level 60. The voltage for any gray level is supplied by the system gamma table in the column drivers, which is well known in the industry.
   1.1.3 Determine a V_{GS} versus current curve for these two pixels. This is done by running up the digital number from 0 to 63 and temporarily recording the resulting currents for the two curves.
   1.1.4 The curves are regressed to third or forth order polynomials and the coefficients stored in memory.
   1.1.5 All display pixels will fall between these two voltage curves. Therefore, create 61 more V_{GS} versus current curves uniformly between the high and low curves and store the coefficients.
   1.1.6 Each curve is numbered from 0 to 63
1.2 Tzero correction (calibrating the pixels)
   1.2.1 Starting with row 1 column 1, use current measuring algorithm to determine which of the 63 I_{D} to V_{GS} curves best describes the driver transistor response to V_{GS}. Store the number of this curve to ROM for pixel 1, 1.
   1.2.2 Proceed to the next pixel, 1, 2, and repeat step 1.2.1.
   1.2.3 Proceed through the rest of the pixels in the display. At the end of this step each pixel has been assigned one of the 63 I_{D}/V_{GS} curves. Some of the pixel curves will fall between two curves. In the case of being restricted to six bits then the nearest gamma table is assigned, but if an extra 2 bits is added then the distance between two tables is divided into 4 segments and a dithering quantity can be assigned to each pixel.

Dithering (Floyd-Steinberg) is a well know technique in the industry to solve the bit quantization problem. The quantization problem is that any system that divides a range of values into discrete steps such as the gray scale system used in displays must always pick one of the levels even though an intermediate value may be more suitable. Therefore, the light emission values of the pixels around the pixel being corrected are adjusted to higher or lower digital numbers (DNs) to produce an average brightness that is closer to the ideal value.

The above described method assigns a voltage to current curve to each pixel that will result in uniform currents being delivered to each pixel. This corrects the initial non-uniformity of the active matrix.

The Apparatus to Measure Current

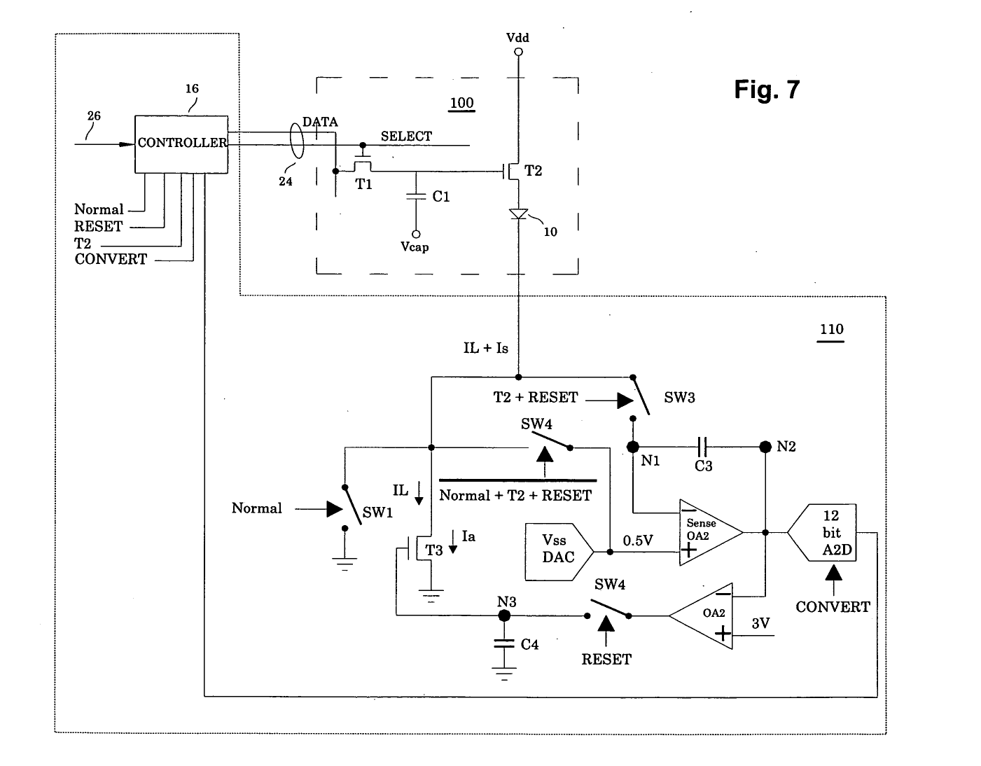

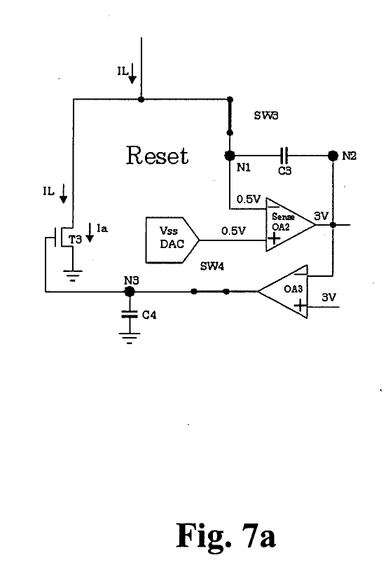

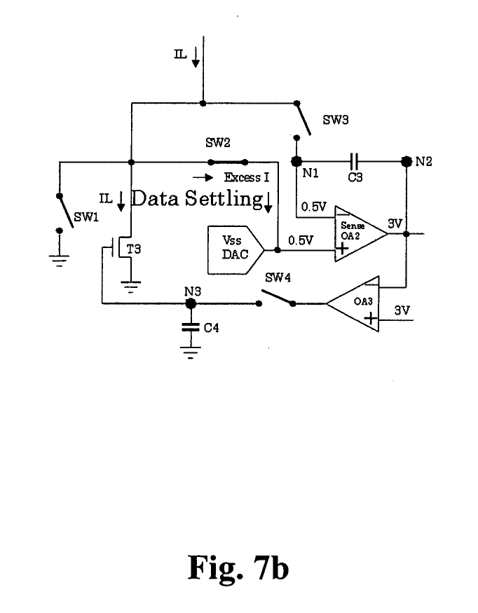

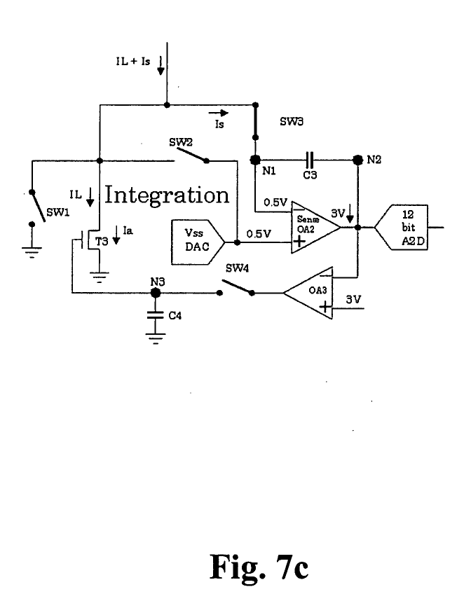

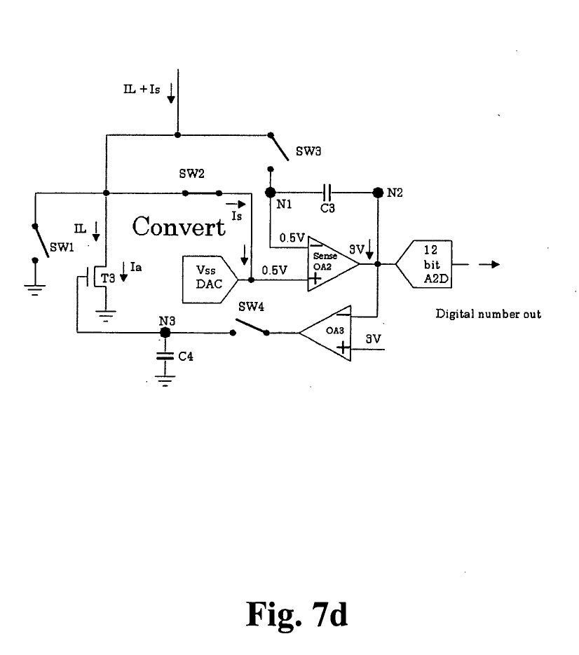

The technology of the present invention measures the current through a single pixel. This current may be small compared to the background current, which is the current through the display when all pixels are turned off. The background current is made of the leakages of transistors and OLEDs in the active matrix. In one embodiment, the background current can be as high as 100 milliamps and the current in one turned on OLED pixel may only be 100 nanoamps (1000 times smaller). The circuitry described herein automatically zeros out the background current and then measures the current from one pixel and converts it to a digital number, for example, a 12 bit digital number. The circuit diagram in the FIG. 7 shows one OLED pixel circuit (100), but it is understood that in actuality there may be 100,000s of pixels in the display array. For each operation of the circuit, switches in the circuit are configured by the controller 16.

According to one aspect of the present invention, the circuit in FIG. 7 can perform an initiate operation. In one embodiment, the initiate operation requires 125 micro seconds (125 μs): the initiate operation begins at T=0 μs and ends at T=125 μs. This operation measures the voltage at node N2 and converts it to a digital number for storage after the field effect transistor (FET) T3 has been set to exactly pass the background current coming from the OLED board without any of the pixels being turned on. In one embodiment, ideally the voltage at N2 in the initiate operation would be the 3V enforced on N2 by the 3V to the non-inverting input of the operational amplifier OA3. In practice, however, there are unavoidable offset voltages in the operational amplifiers which cause the actual equilibrium voltage to deviate from the ideal. The initiate operation records that deviation, which is then subtracted from any voltage values resulting from current changes due to pixels being turned on in subsequent operations.

According to one aspect of the present invention, the first part of the initialization operation includes the reset operation. In one embodiment, the reset operation period is 3 μs long: it begins at T=0 μs and ends at T=3 μs. This operation resets C3 to have the equilibrium charge on it with the background current flowing though T3. FIG. 7a illustrates the position of the pertinent switches of the circuitry FIG. 7 during the reset operation. The equilibrium charge on capacitor C3 is determined by the 3V forced on point N2 by OA3 and the 0.5V forced on N1 by OA2. Therefore, the equilibrium charge is approximately C3×(3V−0.5V). In the equilibrium state for the two op amps (OA2 and OA3) the inputs for each op amp (OA2 or OA3) have equal voltages on them and the outputs of the op amps (OA2 and OA3) adjust to the voltages required to produce equal inputs. The key to the reset process is that feedback is provided to OA2 by C3 and to OA3 by T3. The non-inverting inputs to both op amps (OA2 and OA3) have voltage sources on them which determine the equilibrium voltages on the inverting (negative) inputs. During the reset process switch SW1 is open, switch SW2 is open, switch SW3 is closed, and switch SW4 closed.

Transistor T3 is a current source controlled by a voltage applied to its gate (if it is a FET) or its base (if it is a bipolar junction transistor). With SW1 and SW2 open, the only path to ground is through T3. This means that if T3 does not pass enough current to satisfy the background current from the OLED, the voltage will rise as charge piles up in the parasitic capacitances around the circuit. Since SW3 is closed, the rise in voltage is applied to N1, but N1 cannot rise in voltage because OA2 is forcing N1 to be 0.5V; therefore, the voltage at N2 will decrease. Since N2 is connected to the inverting input to OA3 it will cause a rise in the voltage on the output of OA3, which is connected to N3 through closed SW4. N3 is connected to the gate or base of T3 and the feedback path is completed; therefore, as the voltage rises at N3 the current increases in T3 until it accommodates the background current. At that point everything is in equilibrium. That is, the current through T3 equals the background current from the OLED display (pixels off), the voltage at N1 is 0.5V, the voltage at N2 is 3V and the voltage at N3 is the right voltage to T3 to produce the background current.

According to one aspect of the present invention, the reset operation is followed by the data settling operation. The data settling operation lasts for 2 μs: it begins at T=3 μs and ends at 5 μs. FIG. 7b illustrates the position of the pertinent switches of the circuitry FIG. 7 during the data settling operation. Normally, at the end of the reset, a pixel is turned on. The data settling time is for the additional pixel current to settle before integration and measurement. However, in the initiate period, no pixels are turned on because a voltage is being recorded for the background current. Therefore, there is no need for the settling time. But for simplicity, the initiate period includes the data settling time. The main difference between the data settling and reset operation is that SW2 is closed and SW1, SW3, and SW4 are open. In the initiate operation, all current from the OLED display IL goes through T3. But later, when a pixel is turned on the excess current will be passed to the output of Vss DAC, which is at 0.5 volts in this case. The output of Vss DAC is called a virtual ground. Meanwhile the voltages on the pins of the op amps (OA2 and OA3) remain unchanged.

The data settling period is followed by the integration operation. The integration operation lasts for 100 μs. It begins at T=5 μs and ends at T=105 μs. FIG. 7c illustrates the position of the pertinent switches of the circuitry FIG. 7 during the integration operation. After the settling time, the P2 pulse starts the integration operation. SW2 opens and SW3 closes. In the initiate operation the pixel current Is is zero; therefore no current is integrated and the voltage at N2 remains at 3V. The reason that Is heads for point N1 is that T3 is biased by the voltage trapped on C4, because SW4 is open and can only pass the background current established during the reset operation. Any excess current represented by Is will cause the voltage at N1 to attempt to rise, but since OA2 forces the voltage at N1 to remain at 0.5V, the 3V at N2 will decrease steadily over the integration time. The decrease in voltage at N2 represents charge stored in C3 due to the Is current. The current Is is then easily calculated by the change in voltage at N2 times the capacitance of C3 divided by the integration time of 100 μs. In the initiate operation, however, Is=0 and the voltage at N2 will not change during the integration time in this part of the operation.

The integration operation is followed by the convert operation. The integration operation lasts for 20 μs. It begins at T=105 μs and ends at T=125 μs. FIG. 7d illustrates the position of the pertinent switches of the circuitry FIG. 7 during the integration operation. The voltage value at N2 represents the additional current Is. The convert operation converts the analog voltage to a 12bit digital number which is stored for later reference. In the initiate operation there is no additional voltage; therefore, the voltage at N2 is the reset voltage. The voltage converted and stored is, therefore the value (close to the 3V reference voltage) for zero additional current. During the convert operation, SW2 closes and SW3 opens and freezes the voltage on N2 so that it can be converted to the 12 bit digital number. This ends the Initiate operation.

Pixel 1, 1 is the first pixel in column 1. The pixel currents will be read sequentially starting with pixel 1, 1 and ending with the last pixel in the last row of the display. The initiate operation is identical to the pixel read operations except that no pixel is turned on. The time for the operation is 125 μs. Therefore, a wide QVGA display having 1,440 columns and 240 rows=345,600 pixels can be read in 43.2 seconds. Each pixel can be read ten times in about 7.5 minutes. The operations to read a pixel are the same as those above:

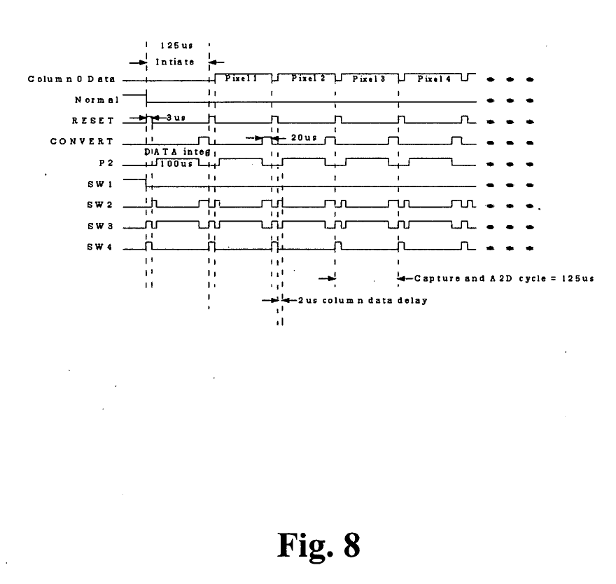

FIG. 8 shows the timing diagram that operates circuit 110 from FIG. 7. The timing signals are controlled by controller 16. These signals are either high or low. A high signal closes a switch and a low signal opens a switch. The switches are controlled by logic gates that are not shown in order to maintain clarity. The logic gate controlling SW1, SW4 and analog to digital converter 12 bit A2D are pass gates since only one timing signal controls them. The logic block for switch SW2 is a three input nor-gate which will only close switch SW2 when the Normal, T2 and RESET signals are low.

Measuring OLED Voltage in Order to Track Aging

FIG. 6a shows the driver transistor in series with the OLED. From the outside world, the only part of the circuit that is accessible is the voltage on the gate, Vg, and the current through the OLED, I_OLED. Therefore, in order to know the V_OLED without adding a transistor and another metal line as in the prior art a means and a method are required to obtain V_OLED using the access points noted above. FIG. 6b shows two curves of V_OLED versus aging time. The curve with the squares is the measured V_OLED obtained with a specials test circuit in the laboratory. The solid curve is calculated from measurements taken on the outside access points noted above. These two curves match very tightly, and thus, prove that the methods and apparatus described in the disclosure are effective.

The Method for Measuring V OLED

The equation that models the field effect MOS transistor when it is in the linear region is:

$${I}_{D } = 2 \cdot k \cdot ( {V}_{G} - {V}_{T} ) \cdot {V}_{SD} - \frac{1}{2} \cdot {V}_{SD}^{2} for {V}_{G} - {V}_{T} \geq {V}_{D } , {V}_{G} > {V}_{T} \qquad Equ . 5$$

Where: I_{D}=Drain current (I_OLED)
k=the same constant is equation 1
V_{G}=gate voltage
V_{T}=threshold voltage
V_{SD}=the voltage drop across the transistor
Solve equation 5 for V_{SD} provides:

$${V}_{SD } = 2 \cdot k \cdot {V}_{G} - 2 \cdot k \cdot {V}_{T} + {( 4 \cdot {k}^{2} \cdot {V}_{G}^{2} - 8 \cdot {k}^{2} \cdot {V}_{G} \cdot {V}_{T} + 4 \cdot {k}^{2} \cdot {V}_{T}^{2} - 2 \cdot {I}_{D } )}^{1 / 2} \qquad Equ . 6$$

The OLED voltage V_OLED is then V_{SD} subtracted from Vdd

$${V}_{D } = Vdd - ⌊ 2 \cdot k \cdot {V}_{G} - 2 \cdot k \cdot {V}_{T} + {( 4 \cdot {k}^{2} \cdot {V}_{G}^{2} - 8 \cdot {k}^{2} \cdot {V}_{G} \cdot {V}_{T} + 4 \cdot {k}^{2} \cdot {V}_{T}^{2} - 2 \cdot {I}_{D } )}^{1 / 2} ⌋ \\ Where \text{:} {V}_{D} = OLED voltage ( V\_OLED ) \qquad Equ . 6$$

Since k and V_{T} were determined from the equations use in the uniformity correction above we are able extract the actual voltage across the OLED using equation 6. The drain current I_{D} is the current obtained when the drive transistor T2 is in the linear region. In order to put transistor T2 in the linear region the voltage drop across transistor T2, and the gate voltage V_{G} minus the threshold voltage V_{T} must exceed V_{SD} the voltage across the transistor (see equation 5 above). Using a methodology similar to the uniformity measurements V_OLED versus I_OLED curves are developed. These curves are compared to the LIV curves saved in memory of which one of the curves is assigned to each pixel. Initially, the first LIV curve is assigned to each pixel, but as the display ages each pixel will age at a rate determined by the pixels usage and the LIV will progress through the 64 stored curves (for a 6-bit system) until the end of life.

How the Display Operates Using the Correction Curves
1. The desired emission level is determined from the gray level data sent by the imaging board.
2. The assigned LIV curve for the first pixel is called from memory and the current required to obtain the desired emission level is determined.
3. The assigned gate voltage to current curve for the first pixel is recalled from memory and the gate voltage required to produce the required current is determined.
4. A lookup table is then used to convert the desired gate voltage (data voltage) to a gray level number is used to determine the correct gray level to send to the display column drivers. Often the desired voltage lies in between two gray levels causing a quantization error.
5. The quantization error is neutralized through the well known use of dithering.
6. This process is repeated for each pixel in the display.

The Apparatus

The apparatus for using the above described aging correction method is the same 20 apparatus used in the uniformity correction method described above with the following usage modification: In the capture apparatus described in FIG. 7, the digital to analog converter Vss DAC is able to increase the ground voltage to reduce the voltage drop from Vdd, and Vdd may also be decreased to bring the total voltage drop down to where V_{SD} has put transistor T2 into the linear region so that equation 6 can be used. Therefore, the difference in usage of the apparatus is the manipulation of Vss DAC to control the operating mode of T2 in order to obtain voltage current information on T2 while in the linear mode.

Although preferred illustrative embodiments of the present invention are described above, it will be evident to one skilled in the art that various changes and modifications may be made without departing from the invention. The respective embodiments described above are concrete examples of the present invention; the present invention is not limited to these examples alone. The claims that follow are intended to cover all changes and modifications that fall within the true spirit and scope of the invention.

We claim:

1. A method for an emissive display, comprising:
providing a driver transistor of an emissive pixel with a plurality of drive voltages;
measuring the current flowing through the emissive pixel as a result of providing each drive voltage to the driver transistor;
storing values associated with the drive voltages and the corresponding measured currents flowing through the emissive pixel in a look up table;
selecting desired current flow value through the emissive pixel;
using the look up table to determine the corresponding drive voltage value for the desired current flow value; and
providing the drive transistor with the drive voltage determined by using the look up table to cause the desired current to flow through the pixel.

2. The method of claim 1, further comprising:
repeating the steps of claim 1 for each of a plurality of pixels of the emissive display.

3. The method of claim 1, wherein the look up table including a memory location for storing digital values of drive voltages and corresponding pixel currents.

4. The method of claim 3, wherein each drive voltage value is stored as a binary number selected from a group consisting of a 8-bit binary number, a 16 bit binary number, a 32 bit binary number, a 64 bit binary number, and a 128 bit binary number, a 256 bit binary number and a binary number having an integer number of digits.

5. The method of claim 4, wherein the binary number stored with a higher number of bits represents a higher resolution of the drive voltage than a binary number stored with a lower number of bits.

6. The method of claim 1, further comprising:
using a mathematical technique of interpoltation to determine a drive voltage value for a desired current flow value; wherein
the desired current value is not a stored value in the look up table; and
the desired current value is in between two stored desired current values in the look up table.

7. A method for an emissive display, comprising:
measuring a plurality of electrical properties for a current driver of an emissive pixel;
associating values with the measured properties; and
using the values associate with the measured properties to mathematically calculate the value of the drive voltage to be provided to a current driver of the emissive pixel for causing a desired current to flow through the emissive pixel.

8. The method of claim 7, wherein the electrical properties include the threshold voltage (V_{T}) of a field effect transistor of the current driver and the proportionality constant (k) of the field effect transistor.

9. The method of claim 8, wherein determining the values of V_{T} and k for a current driver transistor according to the following steps:
providing a voltage signal having a first voltage level to the gate of the driver transistor and measuring the resultant current following through the pixel (I_{D1});
providing a voltage signal having a second voltage level to the gate of the driver transistor and measuring the resultant current flowing through the pixel (I_{D2});
using the first and second voltage level values and the I_{D1} and I_{D2} values to determine the V_{T} and k values for the drive transistor by using the field effect transistor equation.

10. The method of claim 8, wherein k and V_{T} values are used to determine the drive voltage provided to the gate of a current drive transistor for generating a desired current through the current drive transistor.

11. A method for an emissive display comprising:
generating a current table associating values of currents flowing through a pixel material and the corresponding voltages applied to the pixel material to cause the currents to flow through the pixel material;
generating a luminance table associating values of the amounts of light emitted by the pixel material and the corresponding voltages applied to the pixel material to cause the pixel material to emit the light;
generating the current and luminance tables at a selected active usage age point of the pixel material;
repeating the generation of the first and second tables at various active usage age points of the pixel material;
storing the tables in memory; and
for an emissive pixel circuitry fabricated from using the same type of pixel material used to generate the tables, using the current and luminance tables generated at the active usage age point that is approximately the same as the active usage age point of the emissive pixel for determining the voltage level to be provided to the drive circuitry of the emissive pixel for obtaining a desired pixel luminosity; wherein
the active usage age refers to the active application of drive voltage to the pixel material to cause luminance.

12. The method of claim 11, wherein the luminance table associating values of the amounts of light emitted by the pixel material and the corresponding currents flowing through the pixel material.

13. The method of claim 11, wherein the active usage age refers to the active application of drive voltage to the pixel material to cause a current to flow through the pixel material.

14. The method of claim 11 wherein the tables are developed by the steps including;
artificially causing a sample of the pixel material to age by causing an age stimulating current to flow through the sample;
interrupting the aging process during selected time intervals and providing the sample with a range of voltages during each interruption;
measuring the current flowing through the sample for each of the various voltage levels for each interruption;
measuring the luminance of the sample for each of the various voltage levels for each interruption;
generating a table relating the various voltage levels to the measured luminance values of the sample for each interruption;
generating a table relating the various voltage levels to the measured current flow values for each interruption; and
store the tables in a look up table.

15. The method of claim 11, further comprising: developing the tables for various ambient temperature levels.

16. The method of claim 14, wherein the age stimulating current is a multiple of the normal current in order to accelerate the material aging process.

17. The method of claim 11, wherein the emissive material includes an organic light emitting diode (OLED) material.

18. The method of claim 11, wherein the sample includes a material selected from the group consisting of blue color emissive material, green color emissive material and red color emissive material.

19. The method of claim 14, wherein providing the range of voltages includes providing progressively high level of voltages.

20. The method of claim 14, wherein the values included in the tables are regressed to close fitting equations and the equations are stored in the look up table.

21. The method of claim 11, wherein the active usage age of the emissive pixel is determined by using the steps including:
causing the current driver transistor of the pixel circuitry to cause the transistor to operate in the linear region of operation;
measuring the resulting current flowing through the transistor for a selected drive voltage;
repeating the causing and measuring steps for various selected drive voltages; and
selecting the current table that best fits the relationships between the measured currents and their corresponding drive voltages.

22. The method of claim 21, wherein causing the drive transistor to operate in the linear range of operation by causing the gate to source voltage of transistor less the threshold voltage of the transistor to be more than the source drain voltage of the transistor.

23. The method of claim 11, wherein the emissive pixel includes an organic light emitting diode (OLED)

24. A method for measuring a current flowing through an emissive pixel of a flat panel display comprising:
measuring a noise current of the display and associating a value with the measured noise current;
providing a drive voltage to the drive circuitry of the pixel to cause the pixel to output a current including a combination of the noise current and a current caused by the drive voltage;
measuring the output current of the pixel including the combined noise current and the current caused by the drive voltage, and associating a value with the output current;
subtracting the value associated with the noise current from the value associated with the combined output current;
storing a result of a subtraction; wherein
the result of the comparison represents the corresponding pixel current for the drive voltage.

25. The method of claim 24, further comprising:
repeating the steps of claim 1 for a plurality of emissive pixels of the display.

26. The method of claim 24, wherein the values associated with the noise and output currents values include sensed voltage values.

27. The method of claim 26, wherein using a voltage comparator to perform the subtraction; wherein
the sensed voltages associated with the noise current and the combined output current are provided as inputs of the voltage comparator.

28. A flat panel display comprising:
a matrix of pixels;
means for causing a noise current of the display to flow to the ground through a first current path;
means for limiting the current flow capacity of the first current path according to the amount of the noise current;
means for providing a drive voltage to a selected pixel circuitry and causing an output current to flow through the selected pixel, the output current including a combination of the noise current and the current flow caused by the drive voltage; and
means for providing a second path for the output current in excess of the noise current to flow.

29. A flat panel display comprising:
A matrix of pixels;
the drain of a field effect transistor (FET) coupled to the cathodes of light emitting elements of a plurality of pixels of the matrix of pixels;
the source of the FET coupled to the ground;
the FET providing a flow through switch for the noise current of the display to flow to the ground;
an equilibrium circuit coupled to the gate of the FET for adjusting the flow through capacity of the FET according to the noise current of the display;
a drive circuit for providing a drive voltage to a selected pixel circuitry and causing an output current to flow through the selected pixel, the output current including the combination of the noise current and the current flow caused by the drive voltage;
the equilibrium circuit for providing a different path from the flow through switch for the output current in excess of the noise current to flow;
a measurement circuit coupled to the different path for measuring the current flowing through the different path and associating a value to the current flowing through the different path; and
a comparison circuit for comparing the value associated with the current flowing through the different path with a stored value to determine the age of the pixel;
wherein;
the FET provides a flow through path only for the flow of the noise current; and
the equilibrium circuit includes a switch for coupling the separate path to the cathode of the light emitting diode of the selected pixel when the output current of the pixel exceeds the noise current.

30. The method of claim 29, wherein the source of a field effect transistor (FET) is coupled to the cathodes of light emitting elements of a plurality of pixels of the matrix of pixels; and
the drain of the FET is coupled to the ground.

31. The flat panel display of claim 29, wherein the pixel includes an organic light emitting diode (OLED).
